(19) United States
(12) Patent Application Publication
(10) Pub. No.: US 2018/0278495 A1
(43) Pub. Date: Sep. 27, 2018

(54) PROVISIONING OF TELECOMMUNICATIONS RESOURCES

(71) Applicant: British Telecommunications Public Limited Company, London (GB)

(72) Inventors: Carla DI CAIRANO-GILFEDDER, London (GB); Siddhartha SHAKYA, London (GB)

(73) Assignee: British Telecommunications Public Limited Company, London (GB)

(21) Appl. No.: 15/537,719

(22) PCT Filed: Dec. 10, 2015
(86) PCT No.: PCT/EP2015/079250

§ 371 Date: Jun. 19, 2017

(30) Foreign Application Priority Data
Dec. 30, 2014 (EP) 14250122.0

(51) Int. Cl. H04L 12/24; H04L 29/08

(52) U.S. Cl. CPC H04L 41/5054; H04L 67/1012; H04L 41/5096; H04L 41/0896

(57) ABSTRACT

A user request for a service to be provided by a cloud-based data network is provisioned by identifying a plurality of data centers capable of providing the service required by the user, analyzing a plurality of characteristics of paths connecting nodes in the network by which the user and the respective data centers may communicate, identifying a set of such paths whose characteristics are optimized for predetermined service objective criteria and, presenting the user with a choice of paths including bandwidth, latency, etc., allowing a path between the user and a data center to be set up appropriate to a selection made by the user.

### CROSS-REFERENCE TO RELATED APPLICATIONS

The present application is a National Phase entry of PCT Application No. PCT/EP2015/079250, filed on 10 Dec. 2015, which claims priority to EP Patent Application No. 14250122.0, filed on 30 Dec. 2014, which are hereby fully incorporated herein by reference.

### TECHNICAL FIELD

This disclosure relates to provisioning of resources in a telecommunications network, and in particular allocation of resources to services having different requirements for properties such as latency and bandwidth.

### BACKGROUND

Collaborative computing is being used increasingly in scientific fields such as bio-technologies, climate predictions and experimental physics where vast amounts of data are generated, stored in data centers, shared, and accessed to facilitate simulations and validations. Scientific data often needs to be distributed and accessed from geographically disparate areas in real-time and in large volumes e.g. petabytes (10¹⁵ bytes).

The ability to support high bandwidth and low latency on-demand network services is becoming increasingly critical in the provision of network platforms to support collaborative computing and distributed data management where large amounts of data are generated, shared, and accessed to facilitate simulations and validations by customers.

Collaborative computing-associated network services present new challenges to network providers as large bandwidths need to be guaranteed end-to-end, and often end-to-end quality of service needs to be ensured. In such circumstances, network conditions are heavily sensitive to allocated resources, as a single reservation can potentially fill all available resources along certain routes. In addition, service consumers do not always require an end-to-end “bitpipe” with a known destination and time, but may be flexible and benefit from being offered options of timescales and performance. For example a first data center may store certain data and have computational power available immediately, whilst a second data center may have more computational power, but with the necessary bandwidth only available at a later date.

It is therefore desirable to identify an optimal allocation of resources to allow data transfer across networks to, from, or between data centers according to user requirements and the availability of network resources.

In traditional mechanisms for bandwidth reservation a user needing a network service to certain data centers would, by trial-and-error, evaluate various alternatives, trading-off between resource availabilities according to the user's preferences. However the information that a service provider can traditionally expose to the user, such as bandwidth and delay, are insufficient for the user to estimate the overall quality-of-service that can be expected (e.g. interactivity). A user needing on-demand network services faces the undesirable task of finding appropriate data centers by trial-and-error, with limited information of real metrics dictating the quality of the service.

### SUMMARY

According to a first aspect of the disclosure, there is provided a method of allocating network resources in a cloud-based data network by identifying a plurality of data centers capable of providing services required by a user, analyzing a plurality of characteristics of paths connecting nodes in the network by which the user and the respective data centers may communicate, identifying a set of such paths whose characteristics are optimized for predetermined service objective criteria and, for each path in the set, generating a display indicative of characteristics of that path and, in response to a selection input by a user, allocating resources to provide a path selected by the user between a user-connected node and a data center.

According to a second aspect, the disclosure provides network resource allocation apparatus for controlling resources in a cloud-based data network, comprising: a data collator for processing network data relating to a network comprising a plurality of interconnected data centers and network nodes, and for processing inputs from a user interface specifying to service objective criteria; an analyzer for analyzing a plurality of characteristics of paths by which the users and the respective data centers may communicate, and thereby identifying a set of such paths whose characteristics are optimized for service objective criteria received over the user interface; a selection processor for generating a display indicative of characteristics of the set of paths for transmission to the user interface, receiving a user input identifying one of the set of paths, and controlling the network to provide the selected path.

In the embodiment of the disclosure to be described, the characteristics include at least two of connectivity, delay, bandwidth and cost, and the display indicates characteristics of resources available for a plurality of different service types, including a guaranteed-bandwidth service and a “best-efforts” service. The selection of data centers associated with the set of paths selected for association with a first service objective is independent of the selection of data centers associated with the set of paths selected for association with another service objective.

In the embodiment to be described, the user is presented with a set of paths which are Pareto-optimized according to two or more service objective criteria, which preferably are, or include, bandwidth and delay. The criteria for inclusion in the set of paths can include a time window.

It will be recognized that embodiments of the disclosure can be embodied in software run on a general-purpose computer, and the disclosure therefore also provides for a computer program or suite of computer programs executable by a processor to cause the processor to perform the method of the first aspect of disclosure or to operate as the apparatus of the second aspect of the disclosure. The processor to be controlled by the software may itself be embodied in two or more physical computing resources in communication with each other.

The disclosure provides a mechanism that enhances the features of traditional on-demand network services. The disclosure allows translation of network characteristics such as bandwidth and delay, which may be meaningless to users, to characteristics of services, such as the volume of data that can be expected to be transferred, and whether the service can support interactivity. This allows users to make choices amongst options optimized according to their preferences.

Embodiments of the disclosure enable the user to specify his preferences as to when the service is required and the indicative bandwidth required. Full visibility of network connectivity and its availability is then used to carry out a multi-objective optimization across the bandwidth and the delay dimensions independently. This optimization seeks Pareto-optimal solutions: that is, the set of solutions for which none of the objective functions can be improved in value without degrading some of the other objective values. This optimization identifies a set of data center locations and associated network characteristics at given time-slots, and will be discussed in more detail later. These network characteristics are then translated into service characteristics in terms of expected quality of service, which in turn are presented to the user.

Embodiments of the disclosure could be implemented as a cloud-based solution which receives demand requirements from users for example via a web-interface, maintains a real-time view of the network topology and bandwidth availability in time-slots, and can reserve bandwidth for network services over links as requested by users.

### BRIEF DESCRIPTION OF THE DRAWINGS

An embodiment of the disclosure will now be described by way of example with reference to the drawings, in which:

FIG. 1 is a schematic diagram indicative of the various functional elements that co-operate to perform a process according to the disclosure.

FIG. 2 is a schematic of a simplified network illustrating connectivity between two end points of a network.

FIG. 3 is a diagrammatic representation of the availability of bandwidth over on individual links of the network time.

FIG. 4 is a flow diagram illustrating the steps performed by the process.

FIG. 5 is an illustration of a Pareto-optimized selection.

### DETAILED DESCRIPTION

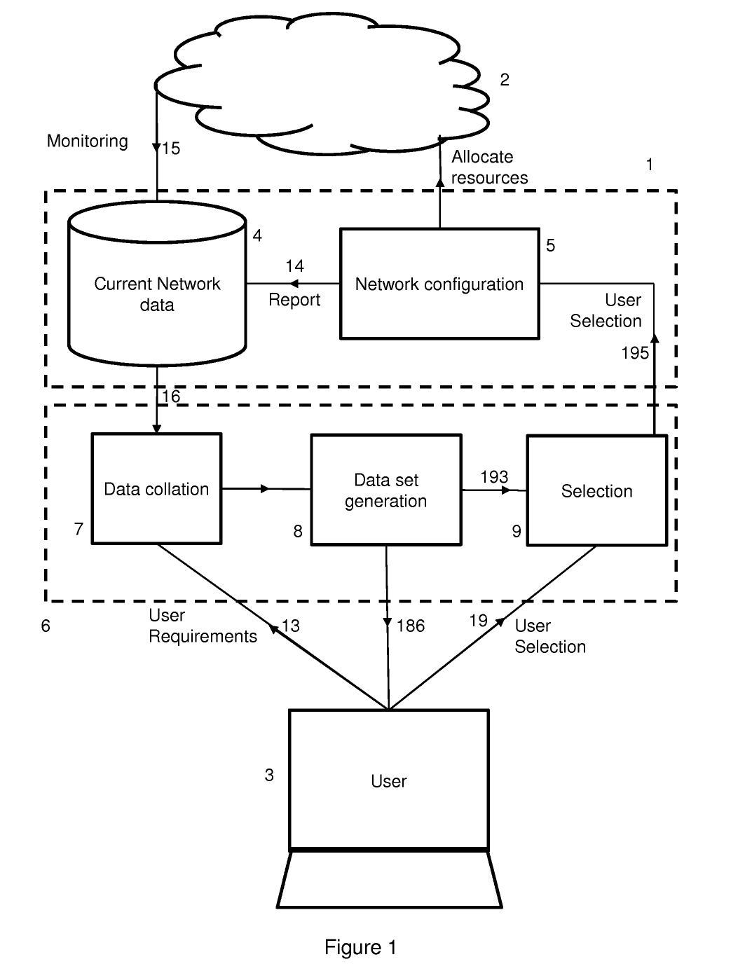

FIG. 1 is a schematic diagram indicative of the various functional elements that co-operate to perform a process according to the disclosure. It will be understood that the individual functional elements may be embodied in software running on a general-purpose computer, or by collaboration between two or more such computers.

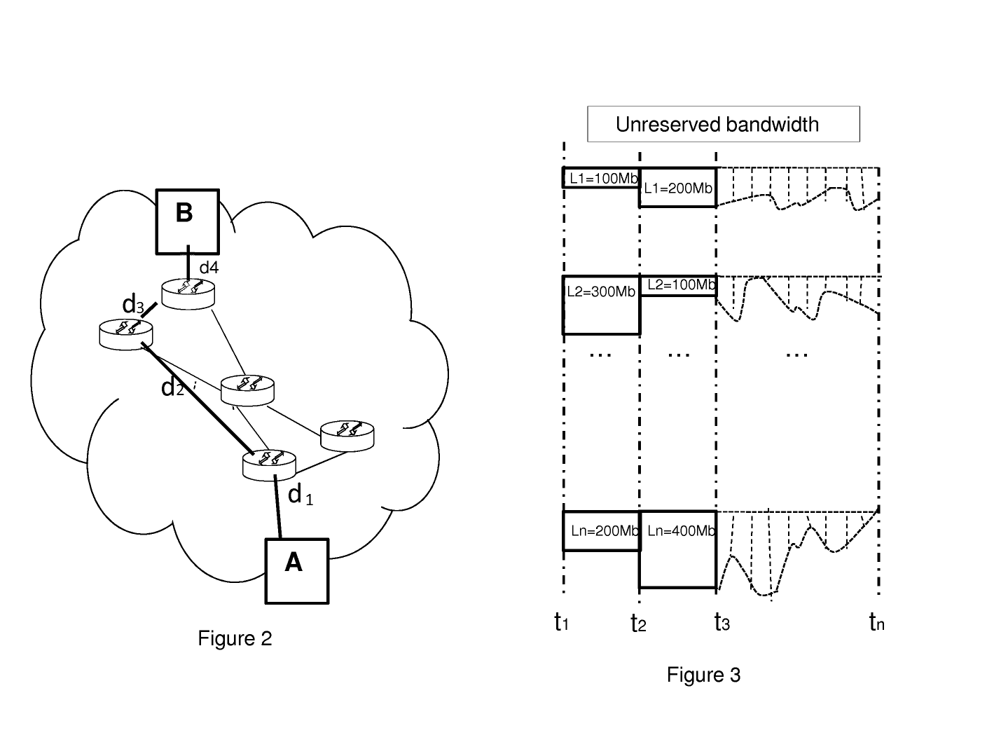

FIG. 1 depicts a network management system 1 which maintains “cloud” resources in a network 2 which are available to be allocated to users (such as user 3) according to their requirements. The network management system 1 comprises a monitoring function 4 which maintains a database of the connectivity of the network and characteristics such as the available bandwidth capacity and delay performance of the individual links in the network. The data maintained in the database will be discussed later in relation to FIGS. 2 and 3.

The network management system 1 also comprises a network configuration system 5 which controls the allocation of resources in the network 2, configures routing through the network, and reports the changes that have been made to the monitoring database 4.

A resource reservation system 6 acts as an interface between the users 3 and the network management system 1, to manage users' requests for network resource. It comprises three stages: a data collation processor 7 which retrieves data from the monitoring database 4 and receives the requirements from the user 3. This data is then processed by a computational processor 8 to identify a set of possible resource allocations, the characteristics of which are returned to the user 3 to make a selection. The user's selection is returned to a selection manager 9 which retrieves the details of the configuration from the processor 8. The selection manager 9 passes the details of the required configuration to the configuration system 5, which sets up the new links in the network 2 and reports the changes to the monitoring database 4.

An example of a simple network is depicted in FIG. 2, which depicts a number of possible routes between two end points marked A and B, and the delay times (one way delay or OWD) d1, d2, d3, d4 for the respective individual links L1, L2, L3, L4 for one possible routing.

FIG. 3 depicts a typical variation in bandwidth over time for each of the plurality of links L1, L2, . . . Ln making up a network (the first two timeslots, from t1 to t2 and from t2 to t3, are shown at an expanded scale). It will be understood that the primary cause for the available bandwidth to vary over time is allocation of bandwidth to applications in response to use requirements. The bandwidth available in future time slots is not fixed, but may change dynamically as the appointed time for the timeslot approaches, as the bandwidth is allocated to meet users' requests. Although transmission times are usually independent of traffic levels, overall end-to-end expected delay may also change over time, namely when heavy traffic causes congestion and gives rise to non-negligible queuing delays.

The system aims to generate a list of data center locations and associated paths from the user which are obtained by means of the above mentioned multi-objective optimization that seeks to meet network resource allocations' objectives independently, using network information maintained in the database 4.

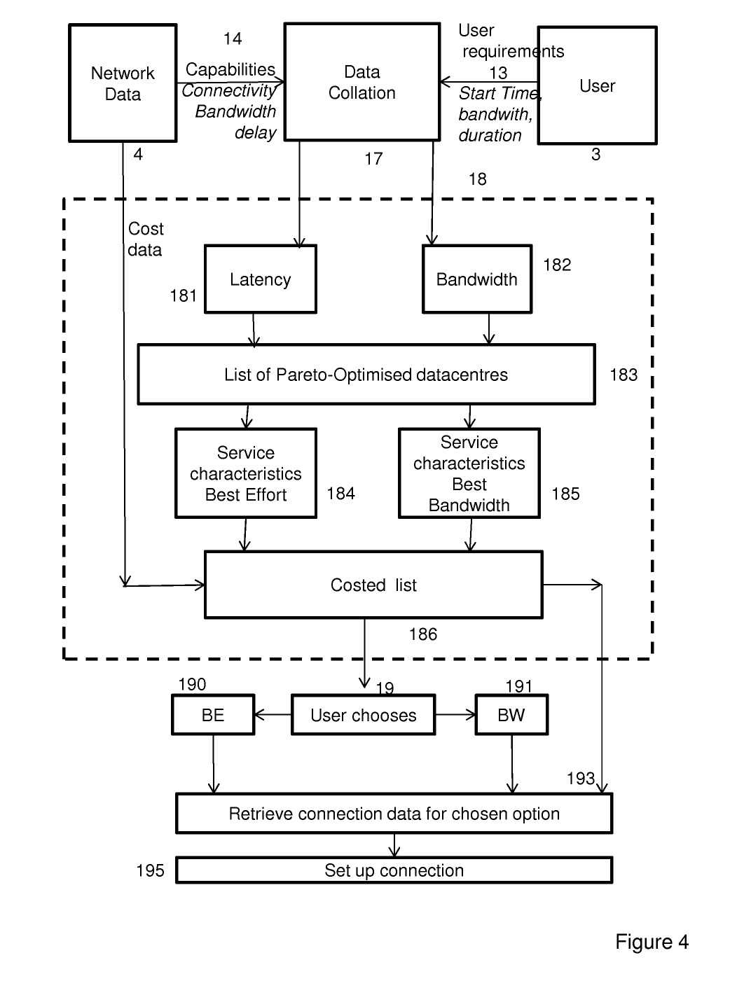

The methodology operating the process is depicted schematically in FIG. 4 and involves the following tasks.

The data required to operate the process is collected by the data collation processor 7 (at 17) and comes from two sources, namely the user 3, and the network monitoring database 4.

Criteria specified by the user 3 are input to the data collator 7 (at 13) when the user requests a service. These criteria typically include the earliest time (T) when the network service is required (the default time being the present), the indicative bandwidth required (B), and the required service duration.

The network monitoring database 4 has a store of data relating to the network capabilities. In particular it has a store of network connectivity and link performance, represented graphically in FIG. 2 and, for each link, its bandwidth availability in each of a plurality of timeslots t1, t2, t3, . . . . tn for each of a number of links L1, L2, . . . Ln, represented graphically in FIG. 3. This data is maintained and updated from time to time as bandwidth is allocated (at 14) and as performance is monitored (at 15), and retrieved by the data collator 7 (at 16) in response to a user request (at 13).

Using the data collected, a multi-objective optimization is performed by the data set generator 8 (at 18). This optimization is based on the known connectivity between nodes (ref. FIG. 2), per-link bandwidth availability per slot (ref. FIG. 3) and per-link One-Way Delay (OWD) (ref. FIG. 2) and aims to identify m locations and time-slots between [T, T+Δ] Pareto-optimized for minimizing end to end delay and maximizing bottleneck bandwidth, where Δ is a time interval of arbitrary length, and optimization is run independently over the delay and bandwidth dimensions.

Although minimizing delay and maximizing bandwidth are both desirable, there may not exist a data center, and a path to it, that achieves both. The Pareto-solution allows a compromise by identifying paths to data centers such that if an alternative path with a shorter delay exists, this would have an inferior bandwidth and, contrariwise, if a path with a greater bandwidth exists then this would have a worse delay. Typically there will be a plurality of such solutions in the dataset: comparing any two members of the solution dataset, one member will have a better delay, and a worse bandwidth, than the other—if one member of the set were superior to another in both (all) respects, the inferior member would not be a member of the Pareto-optimized set.

For each possible path, the total delay over the links in that path is determined (at 181), and the link with the smallest bandwidth (the bottleneck) is identified (at 182) as this determines the bandwidth of the path as a whole. The path with the largest (least restrictive) bottleneck is then selected as a possible candidate solution. Any data center which is not reachable by any path with a bottleneck bandwidth greater than the minimum indicative value B (specified by the user in the initial data collation at 13) is eliminated from consideration.

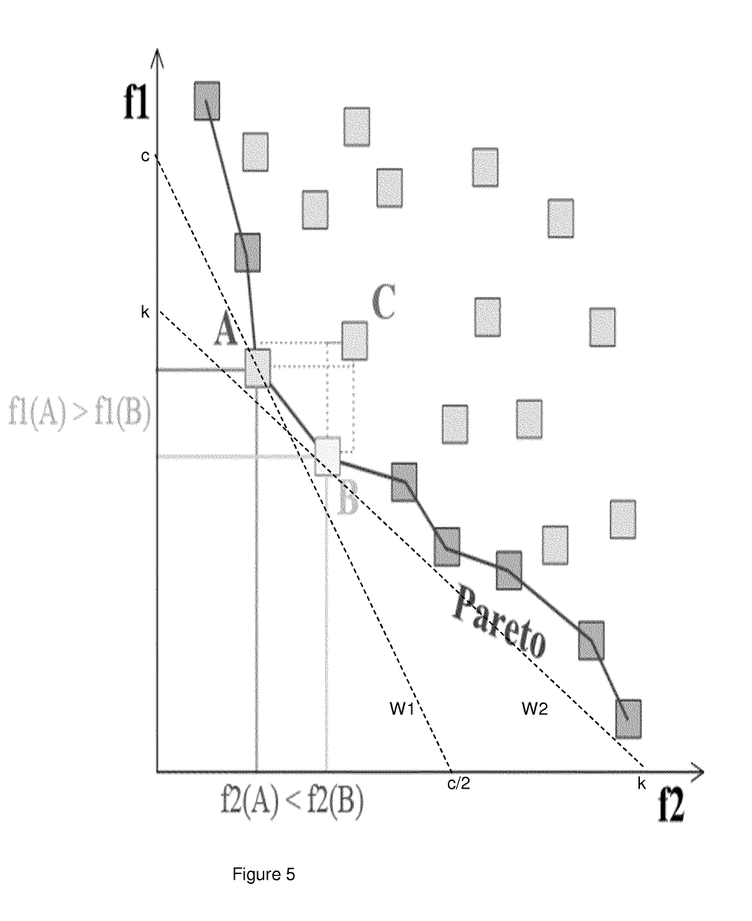

A Pareto optimization is then carried out. This identifies a solution set of all paths for which no parameter (in this example neither delay nor bandwidth) can be made more optimal by changing to another path without detriment to the other parameter (or, it excludes any path if another path exists whose parameters are all superior to those of the first path). A two-dimensional example is shown in FIG. 5. The two parameters, to be interpreted as delay and bandwidth of the f1 and f2 optimizations of the present disclosure, are illustrated along the axes f1, f2 and the potential datapoints to be considered—to be interpreted as network paths—are shown as square blocks. The optimized solutions are linked by the line marked “Pareto”. The other points are non-optimal: taking datapoint “C” as an example, there is at least one datapoint (in this case, two datapoints; A and, B) for which the respective values of both f1 and f2 are lower (better) than for datapoint C. The set of Pareto datapoints, (e.g. A,B) are those for which no other datapoint has better values for both properties f1, f2. Thus for datapoint A, although datapoint B (and nine other datapoints) have superior (lower) values for the property f1, and three datapoints have superior values for the property f2, there is no datapoint with a superior value for both properties.

If the relative importance (weighting) of the properties f1, f2 were known, an optimum datapoint could be determined. As shown in FIG. 5, the gradients of the two lines W1, W2 represent different weightings (the gradient of line W1 (in which property f1 is twice as important as property f2) being twice that of line W2 (in which properties f1 and f2 are of equal weight), and provide different optimal datapoints A, B respectively. However, such weightings will depend on the user and can be both subjective and non-linear: for example subject to an absolute minimum quality. The present disclosure offers the user a choice of datapoint solutions, namely data centers and associated network paths, but limits that choice to the Pareto-optimized set.

The data set generator 8 therefore identifies a set of solutions (at 183), each representing a network data center and associated network characteristics as follows:

DCx(Tstart,BW,OWD,s) x=1 . . . m

Where: Tstart=Slot start time
BW=Bandwidth available (using the best available path) in the time interval [Tstart, Tstart+s], this means that a network path to Xi with at least BW is available for reservation
OWD=One-way delay of the identified network path which is defined as the sum of the per-link OWD transmission delay, plus any queuing delays if these can be expected to be non-negligible during the given time slots, considering the network load.

For each of the data centers DCx identified (at 183), the system calculates characteristics of a best-effort service (i.e. with no bandwidth guarantees) (at 184) and for a guaranteed-bandwidth service (at 185). For the guaranteed bandwidth service, service characteristics for each solution (at 185) are expressed in terms of interactivity level Lx as follows:

| Round trip delay* | Interactivity level |
|---|---|
| RTT < x ms | L1 (best) |
| x ms ≤ RTT < y ms | L2 (moderate) |
| y ms ≤ RTT | L3 (poor) |

where RTT=2*OWD as defined above, assuming delay times are symmetrical in both directions.

For example, in typical modern networks:

| Round trip delay | Interactivity level L |
|---|---|
| RTT <100 ms | L1 (best) |
| 100 ms ≤ RTT < 400 ms | L2 (moderate) |
| 400 ms ≤ RTT | L3 (poor) |

For the alternative best-effort service (i.e. with no bandwidth guarantees) (at 184) the characteristics are calculated in terms of data volume that can be transferred in the interval [Tstart, Tstart+s], over the identified network path as a function of expected data throughput Rm:

Rm=f(delay,v1, . . . , vn), vi i=1, . . . n. variables

where data throughput (often referred to as goodput) is obtained as a function of delay and other network related-parameters vi, i=1, . . . n.

For example, goodput Rm, assuming TCP-based transport layer communication as it is dominant today, can be obtained using the Mathis TCP throughput formula [Mathis, Semke, Mandavi and Ott: “The Macroscopic Behaviour of The TCP Congestion Avoidance Algorithm”: ACM SIGCOMM Computer Communication Review 27(3): 67-82, 1997] as follows:

Rm=(MSS/2*OWD)*(C/sqrt(px))

where C=0.93, MSS=1460 Bytes (packet payload), and px is non-zero network loss. Network loss data can either be assumed to be collected by the Data Collation function (7) for the given paths and time-slots or can be inferred depending on the distance from user to data center location according to the following heuristics:

If data center is local (e.g. OWD<d1 ms) then px=p1

If data center is regional (e.g. d1 ms<OWD<d2 ms) then px=p2

If data center is within a continent (e.g. d2 ms<OWD<d3 ms) then px=p3

If data center is across multiple continents (e.g. d3<OWD) then px=p4

The volume Vm of data that can be transferred in the slot-length s (here assumed in minutes) can be determined from the throughput Rm as follows:

Vm=(Rm/8)*60*s
(in MBytes assuming Rm is in Mbps)

For each of the identified data centers DCx and associated paths (at 183), characteristics for a best-effort service (at 184) and for a guaranteed-bandwidth service (at 185) can therefore be calculated, and from these values a list of service costs is compiled (at 186) This list specifies the cost to the user depending on whether the services are taken on a bandwidth guaranteed (BG)-basis. If a best-effort option is available at a lower cost (as will generally be the case) this will be offered as well. Costing functions may be defined as follows, to be dependent on the bandwidth and service duration:
CBE(s,BW)=f(s, BW) where CBE refers to the cost of the BE option
CBG(s, BW)=g (s, BW) where CBG refers to the cost of the BG option
with CBE(s,BW)<CBG(s, BW)

Thus the user 3 can be sent a list of m data center locations DC1, . . . , DCm and associated service characteristics (at 186), identifying for each data center the characteristics for that center if operated on a guaranteed bandwidth basis, and if operated a best efforts basis, as well as related costs.
DCx (Tstart, BW, s, Vm, L, CBE(s,BW),CBG(s,BW)), x=1, . . . , m
Where: Tstart=Slot start time
W=Bandwidth that can be guaranteed in time interval [Tstart, Tstart+s]
Vm=Data volume that can be transferred in time interval [Tstart, Tstart+s], on a best-effort basis with no bandwidth guarantees
L=Interactivity level, if service taken with guaranteed bandwidth
CBE(s,BW)=cost of service if best-effort service chosen
CBG(s,BW)=cost of service if bandwidth guaranteed service chosen

The details of the path and switching are maintained by the data set generation processor 8, but do not need to be communicated to the user 3, who only needs to know the performance characteristics of each path data center that is available, and not the details of how that performance is implemented.

The user is given a plurality of options to provide the requested bandwidth, presented as best efforts and guaranteed bandwidth services, involving a number of different data centers. The user 3 can then select one of the offered services (at 19). The user's selection is transmitted to a selection processor 9 which retrieves, from the data set generation processor 8, the details of the data center and path that provide that service (at 190). For example if an interactive service is required, among the various options offered of the form:
DCx (Tstart, BW, s, Vm, L, CBE(s,BW),CBG(s,BW))
   the user will choose among those DCx with the best L parameter and, depending on the criticality of the service requirement, may choose to buy the service on best-effort basis, or on a bandwidth guaranteed basis.

It the user selects a bandwidth-guaranteed service (at 191), then the selection processor 9 instructs the network configuration processor 5 to reserve bandwidth BW in the time slot [Tstart, Tstart+s] over all links identified in the path to DCx (at 195). The user can expect that both end-points of the communication can inject in the network at rate BW for duration s; in addition the user can expect interactivity level L and indicatively at least Vm data volume transfer (volume Vm if transport based by TCP-based protocols with larger volumes possible with protocols such as UDP).

Alternatively if the user selects a best-effort service (at 190), then the end-points of the transmissions (either the user or the DCx's server) cannot inject in the network more than BW and the selection processor 9 system only causes the network configuration processor to reserve bandwidth BWBE=a*BW, in the time slot [Tstart, Tstart+s] over all links identified in the path to DCx, (at 195), where 0<α<1 depends upon the over-booking policies adopted by the network provider for its best-effort traffic.

1. A method of allocating network resources to users in a cloud-based data network comprising:
identifying, for each user, a plurality of data centers capable of providing services required by the user;
analyzing a plurality of characteristics of paths connecting nodes in the network by which the user and each of the identified data centers may communicate;
identifying a set of such paths, each path having characteristics optimized for criteria defined by a respective predetermined service objective;
for each path in the set, generating a display indicative of characteristics of that path, the characteristics including the time at which the path will be available; and
in response to a selection input by the user, allocating resources to provide a path selected by the user between a user-connected node and a data center.

2. A method according to claim 1, wherein the characteristics include at least two of connectivity, delay, bandwidth or cost.

3. A method according to claim 1, wherein the display indicates characteristics of resources available for a plurality of different service types.

4. A method according to claim 3, wherein the service types include a guaranteed-bandwidth service.

5. A method according to claim 3, wherein the service types include a best efforts service.

6. A method according to claim 3, wherein the selection of data centers associated with the set of paths selected for association with a first service objective is independent of the selection of data centers associated with the set of paths selected for association with another service objective

7. A method according to claim 1, wherein the set of paths identified is Pareto optimized with two or more service objective criteria.

8. A method according to claim 7, wherein the service objective criteria include bandwidth and delay.

9. A method according to claim 1, wherein the criteria for inclusion in the set of paths for display include a time window.

10. Network resource allocation apparatus for controlling resources in a cloud-based data network, comprising:
a data collator for processing network data relating to a network comprising a plurality of interconnected data centers and network nodes, and for processing inputs from user interfaces specifying service criteria defined by predetermined service objectives and the nodes to which the specified services are to be delivered;
an analyzer for identifying one or more of the data centers capable of providing the services specified in the inputs received from the user interfaces, and analyzing a plurality of characteristics of paths by which each node may communicate with the data centers so identified, and thereby identifying a set of such paths, each path having characteristics optimized for a respective service objective received from a respective user interface, the characteristics including the time at which the path will be available; and
a selection processor for
generating a display indicative of characteristics of the set of paths for transmission to the user interface,
receiving a user input identifying one of the set of paths, and
controlling the network to provide the selected path.

11. A network resource allocation system according to claim 10, wherein the selection processor generates sets of paths available for a plurality of different service types.

12. A network resource allocation system according to claim 11, wherein the service types include a guaranteed-bandwidth service and a best efforts service.

13. A network resource allocation system according to claim 10, wherein the analysis system is arranged to generate a Pareto-optimized set of paths with two or more service objective criteria.

14. A network resource allocation system according to claim 10, wherein the service objective criteria include bandwidth and delay.

15. A non-transitory computer-readable storage medium storing a computer program or suite of computer programs executable by a processor to cause the processor to perform the method of claim 1.
